(19) United States
(12) Patent Application Publication
(10) Pub. No.: US 2006/0050070 A1
(43) Pub. Date: Mar. 9, 2006

(54) Information processing apparatus and method for presenting image combined with virtual image

(75) Inventor: Taichi Matsui, Yokohama-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/217,804

(22) Filed: Sep. 1, 2005

(30) Foreign Application Priority Data
Sep. 7, 2004 (JP) 2004-259626

(51) Int. Cl. G06T 15/00

(52) U.S. Cl. 345/419

(57) ABSTRACT

An information processing method and an information processing apparatus for preventing a user from experiencing fear in a virtual environment due to the area surrounding their feet being invisible because of CG masking the real space are provided. The information processing method and apparatus acquire the position and posture of the user when generating an image of a virtual reality and combining the image of the virtual reality with an image of real space to present the combined image to the user. When the user is inside a virtual building, the information processing method and apparatus generate objects inside the virtual building and a transparent object and combine the generated objects with an image of real space. By displaying the combined image, the image of real space is displayed at the feet of the user.

### BACKGROUND OF THE INVENTION

1. Field of the Invention

The present invention generally relates to an information processing apparatus and an information processing method and, in particular, to an information processing apparatus and a method for presenting users with an image in which an image capturing the real space is combined with a virtual image.

2. Description of the Related Art

Virtual reality (VR) systems provide users with a virtual reality by presenting them with three-dimensional computer graphics (CG) created by a computer. In recent years, a technology that presents information that is nonexistent in the real space to users by combining three-dimensional graphics with an image of the real space has been developed. Such systems are referred to as an augmented reality (AR) system or a mixed reality (MR) system.

In MR systems, users can view three-dimensional CG superimposed on a real object. An MR system has been proposed in which a user can freely manipulate a virtual object by superimposing the virtual object on a real object (refer to, for example, Japanese Patent Laid-Open No. 11-136706, which corresponds to U.S. Pat. No. 6,522,312).

In general, since the MR system displays CG over a real image, the CG masks some parts of the user's feet and hands, and therefore, a user cannot see those parts. For example, in an MR system that allows a user to experience the interior environment of a virtual building, when the user moves into the virtual building, a virtual floor and a virtual wall cover the entire vicinity of the user. Accordingly, in such a system, CG covers the surroundings of the user's hand, and therefore, the user feels some inconvenience when manipulating something.

Additionally, if the CG masks the area surrounding the user's feet, the user may feel afraid.

### SUMMARY OF THE INVENTION

The present invention provides an information processing apparatus and an information processing method for preventing a user from experiencing fear in a virtual environment due to the area surrounding their feet being invisible because of CG masking the real space.

The present invention further provides an information processing apparatus and an information processing method that allow a user to view the real space surrounding their feet.

According to an aspect of the present invention, an information processing method generates an image of a virtual reality and combines the image of the virtual reality with a real-space image to present a combined image to a user. The information processing method includes the steps of acquiring the position and posture of the user and generating the combined image corresponding to the position and posture of the user based on the position and posture of the user and computer graphics data of the virtual reality such that the real-space image is displayed at the feet of the user.

According to another aspect of the present invention, an information processing apparatus generates an image of a virtual reality and combines the image of the virtual reality with a real-space image to present a combined image to a user. The information processing apparatus includes an acquiring unit configured to acquire the position and posture of the user and a generating unit configured to generate the combined image corresponding to the position and posture of the user on the basis of the position and posture of the user and computer graphics data of the virtual reality such that the real-space image is displayed at the feet of the user.

Further features of the present invention will become apparent from the following description of exemplary embodiments with reference to the attached drawings.

### BRIEF DESCRIPTION OF THE DRAWINGS

FIG. 1 illustrates a block diagram of a system according to an exemplary embodiment of the present invention.

FIG. 2 illustrates scene graphs of a virtual reality according to the exemplary embodiment.

FIG. 3 illustrates a space that allows a user to experience an MR system according to the exemplary embodiment.

FIG. 4 is a flow chart of a process according to the exemplary embodiment.

FIG. 5 illustrates a diagram in which a user is standing in a composite real space.

FIG. 6 illustrates a diagram in which a user in a composite real space looks down vertically.

FIG. 7 illustrates a diagram in which a user is standing in a composite real space having a transparent object.

FIG. 8 illustrates a diagram in which a user in a composite real space having a transparent object looks down vertically.

FIGS. 9-11 illustrate exemplary transparent objects having different shapes.

### DESCRIPTION OF THE EMBODIMENTS

Exemplary embodiments of the present invention are described in detail with reference to the accompanying drawings.

### First Embodiment

In a first embodiment, an MR system that allows a user to experience the interior environment of a virtual building is described.

The entire system configuration is described next.

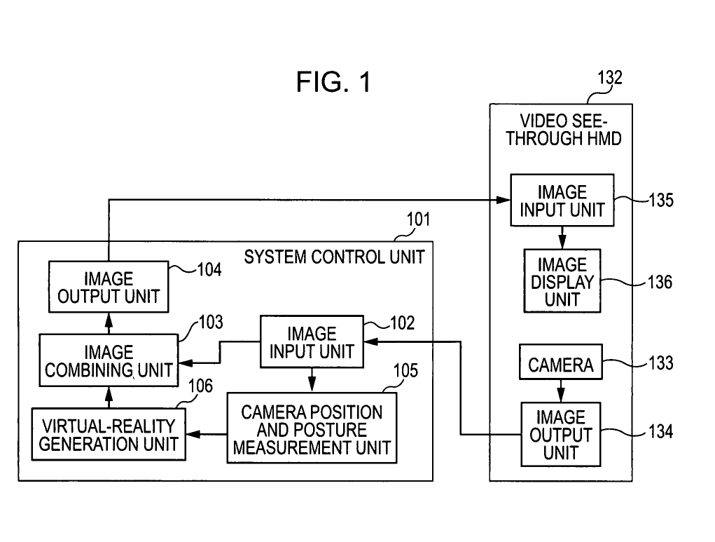

FIG. 1 illustrates a block diagram of the system according to the first embodiment of the present invention. As shown in FIG. 1, a system control unit 101 carries out overall control of the system. The system control unit 101 includes an image input unit 102, an image combining unit 103, an image output unit 104, a camera position and posture measurement unit 105, and a virtual-reality generation unit 106.

A video see-through head-mounted display (HMD) 132 includes a camera 133, an image output unit 134, an image input unit 135, and an image display unit 136. Two cameras 133 are provided to correspond to the user's right and left eyes. The image display unit 136 includes two display portions corresponding to the user's right and left eyes.

The data flow in the system having such a structure is described next.

The cameras 133 of the HMD 132 mounted on the user's head capture images of the real space viewed from the right and left eyes of the user. The image output unit 134 transmits the images of the real space captured by the cameras 133 to the image input unit 102 of the system control unit 101.

The camera position and posture measurement unit 105 uses, for example, a magnetic position and posture sensor (not shown) or estimates the position and posture of the cameras 133 from the input images so as to measure the position of the cameras 133 (i.e., position of the user) and the posture of the cameras 133 (i.e., the posture or the direction of the line of sight of the user). The virtual-reality generation unit 106 generates three-dimensional CG viewed from the position and posture of the cameras 133 on the basis of the position and posture information measured by the camera position and posture measurement unit 105 and prestored scene graphs.

Here, the scene graphs represent the structure of the virtual reality. For example, the scene graphs define the positional relationship and geometric information among CG objects. In this embodiment, in addition to objects that define the virtual reality experienced by a user, the scene graphs describe a transparent floor object in order to display an image of the real space at the feet of the user.

The image combining unit 103 combines the images of the real space received by the image input unit 102 with a virtual-reality image (three-dimensional CG image) generated by the virtual-reality generation unit 106 so as to generate a composite real-space image. The image combining unit 103 then transmits the generated composite real-space image to the image output unit 104. The image output unit 104 transmits the composite real-space image formed by the image combining unit 103 to the image input unit 135 of the HMD 132. The image input unit 135 receives the composite real-space image transmitted by the image output unit 104. The image display unit 136 displays the composite real-space image received by the image input unit 135 on the display portions for the right and left eyes of the user. Thus, the user can observe the composite real-space image.

In this system, a composite real-space image can be displayed in accordance with the position and posture of the user wearing the HMD on their head. Accordingly, the user can freely experience an MR space environment.

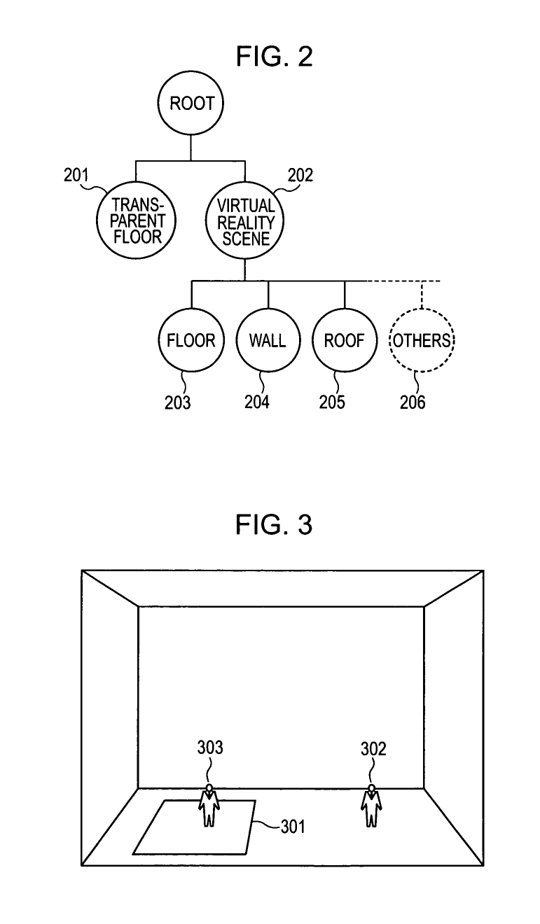

FIG. 2 illustrates the tree structure of scene graphs used in this embodiment.

Since an MR system that enables a user to experience a virtual building is described in this embodiment, the MR system includes a virtual reality scene 202, which represents objects of the virtual building, and a transparent floor 201, which is an object for displaying a real-space image by making a CG floor transparent.

The virtual reality scene 202 includes, for example, a floor object 203, a wall object 204, and a roof object 205 in the interior of the virtual building and other objects 206 in the exterior of the virtual building. Accordingly, when the user enters the virtual building, CG of a floor at the user's feet exists as well as CG of a wall and a roof.

The object of the transparent floor 201 is an object having a transparent property. The transparent floor 201 exists on a path in which a search for the transparent floor 201 is performed prior to the virtual reality scene 202 being displayed. The size of the plane of the object is set to the size at which the designer of the MR system wishes to display the real world by making a virtual-reality image transparent. The height of the plane of the object is set to the same value as or slightly larger than the thickness of the floor in the scene.

For example, when the thickness of the floor object 203 is 10 mm and the designer wishes to display a real image inside a circular region having a diameter of 1 m, the object of the transparent floor 201 is determined to be a cylinder whose height is 12 mm and whose diameter is 1 m.

Such a scene graph allows the transparent floor 201 to take precedence over the floor object 203 when rendering an object. Accordingly, the image combining unit 103 combines the real image and the transparent image. As a result, the real image is displayed in the region of the transparent floor 201.

Additionally, a transparent object follows the translation of the camera 133 (i.e., movement of a user). The MR system determines the horizontal position of the transparent object on the basis of positional information output from the camera position and posture measurement unit 105. The MR system also determines the height (vertical position) of the transparent object to be the same height as the floor of the virtual reality. Thus, while the transparent object is on the same plane as the floor of the virtual reality, only the horizontal position can follow the translation of the camera 133. That is, since the transparent object is always disposed directly beneath the user, the user can view the real space at their feet. If the height of the floor of the virtual reality changes, the height of the transparent object also changes in conjunction with the change in the height of the floor of the virtual reality. Thus, even in an application that changes the height of the floor, the region of the virtual floor can always be transparent.

Since the thickness of the transparent object is substantially the same as that of the virtual floor, the transparent object does not make an object directly above the transparent object transparent and invisible.

Some graphics libraries automatically change the order in which objects are displayed to display an object prior to the transparent object. When using such libraries, a mode in which objects are directly combined and displayed without changing the display order of the objects can be selected.

The space in which a user can experience the MR system according to this embodiment is described next. FIG. 3 illustrates the space that allows a user to experience the MR system according to the embodiment.

The space shown in FIG. 3 is surrounded by a floor, a wall, and a roof in the real space. A virtual building is displayed in a region 301. When a user is located outside the region 301 (e.g., at a position 302), the user can view the exterior of the virtual building. When a user is located inside the region 301 (e.g., at a position 303), the user can view the interior of the virtual building.

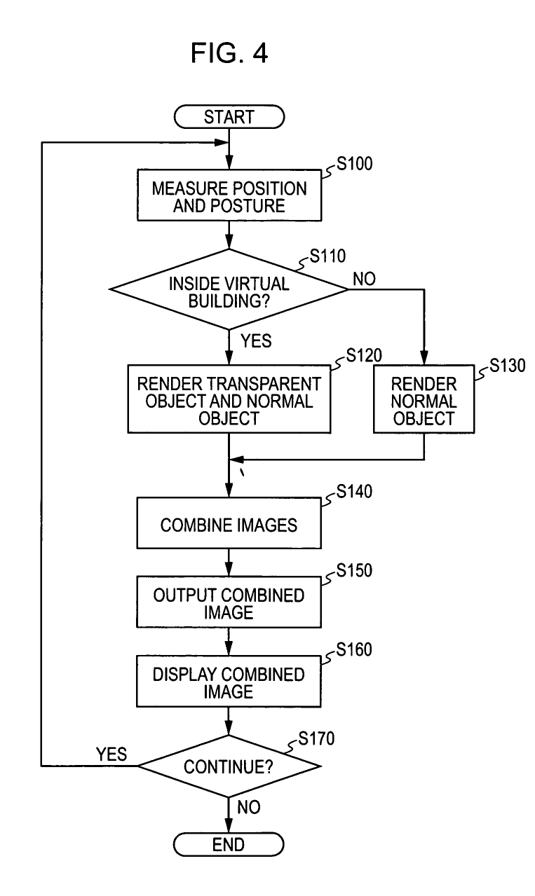

The process according to this embodiment is described next with reference to a flow chart shown in FIG. 4.

At step S100, the camera position and posture measurement unit 105 measures the position and posture of the camera 133 (i.e., the position and posture of a user). At step S110, the virtual-reality generation unit 106 determines whether the user is located inside the virtual building on the basis of the position and posture measured. If the virtual-reality generation unit 106 determines that the user is located inside the virtual building, the virtual-reality generation unit 106 generates a virtual reality image based on a transparent object and objects in the building (step S120). If the virtual-reality generation unit 106 determines that the user is not located inside the virtual building, the virtual-reality generation unit 106 generates a virtual reality image based on objects outside the building (step S130).

Subsequently, at step S140, the image combining unit 103 combines the virtual reality image generated at step S120 or S130 with a real-space image received by the image input unit 102. At step S150, the image output unit 104 outputs the combined image to the HMD 132. Thereafter, at step S160, the HMD 132 respectively displays images on the right-eye and left-eye display portions of the image display unit 136. The process of steps S100-S150 is repeated until it is determined in step S170 that it is time to stop. When it is determined in step S170 that it is time to stop, processing shown in FIG. 4 ends.

The resultant display and its effect according to the embodiment are described with reference to FIG. 3 and FIGS. 5 through 8.

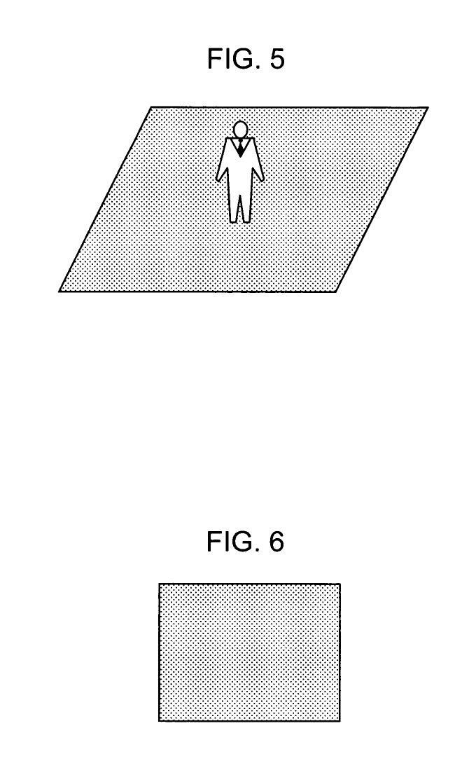

A known MR system (i.e., an MR system having no transparent object) is described with reference to FIGS. 3 and 5.

A floor region 301 shown in FIG. 3 is a region where a virtual building in the real world is displayed. FIG. 5 illustrates a diagram in which a floor of the virtual reality is superimposed over the floor region 301 of the real world and a user is standing in the floor region 301. At that time, when the user looks down vertically through an HMD, the user only sees the CG of the floor, as shown in FIG. 6. This is because the CG of the floor masks an image of the real space. In general, if the CG masks the surroundings of the user's feet, the user who experiences the MR system may feel afraid.

The MR system according to this embodiment (i.e., an MR system having a transparent object) is described next. In this embodiment, a transparent object is disposed on the same plane as a floor of the virtual reality. Consequently, the cylinder-shaped transparent object is disposed directly underneath a user, and therefore, the user can view an image of the real world through the transparent object.

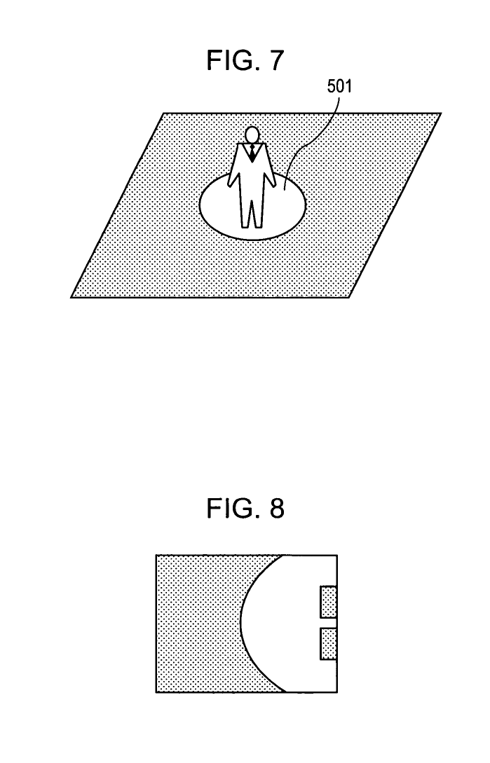

FIG. 7 illustrates a diagram in which a floor of the virtual reality and a transparent object 501 are superimposed over the floor region 301 of the real world and a user is standing in the floor region 301. At that time, as shown in FIG. 8, when the user looks down vertically through the HMD 132, the user can view real space, which includes the user's feet, in the shape of the transparent object 501. Consequently, the user who experiences the MR system does not feel afraid due to the surroundings of their feet being invisible.

Furthermore, the user can view the surroundings of their hands if the surroundings are within the image area of the real world. Therefore, the user can carry out an operation with their hands while viewing an image of the real world. Thus, the user can carry out an operation with their hands more easily than in the case where the surroundings of their hands are masked by CG.

As used herein, “surroundings of the user's feet” is referred to as a predetermined area at the center of which is the user. As described below, the surroundings of the user's feet is also referred to as a predetermined area starting from the user's position in the moving direction of the user or a predetermined area distant from the user by a predetermined distance.

### Other Embodiments—Modification of Transparent Object

In the above-described embodiment, the transparent object has a cylindrical shape. However, the transparent object may have another shape, such as a rectangle parallelepiped.

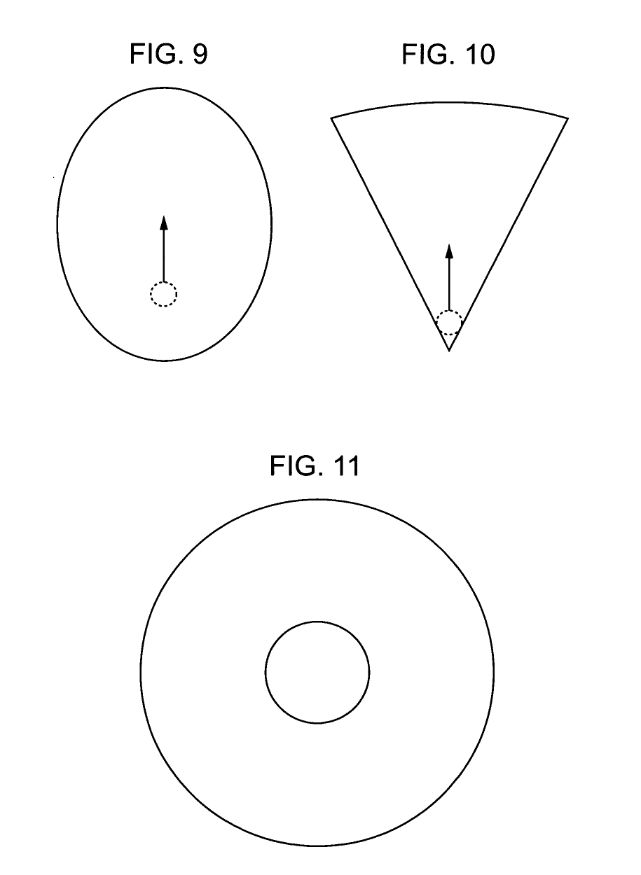

Furthermore, the shape of a transparent object may change depending on the moving speed of a user. For example, as shown in FIG. 9, the shape of a transparent object may be an elliptical cylinder. The major axis of the elliptical cylinder is oriented towards the moving direction of the user (an arrow shown in FIG. 9 coincides with the moving direction of the user). The direction of the major axis is used as a reference direction for the user to move forward. The lengths of the major axis and the minor axis of the elliptical cylinder change in proportion to the moving speed so that the lengths are used as reference values for the user to obtain their current moving speed.

Additionally, the major axis of the elliptical cylinder may be oriented towards the line of sight of the user (an arrow shown in FIG. 9 coincides with the direction of the line of sight of the user).

In FIG. 9, a circle shown by a dashed line indicates the position of the user. As shown in the drawing, the position of the user may be offset from the center of the elliptical cylinder in the moving direction or in the direction of the line of sight of the user.

Furthermore, in addition to the shape of a cylinder and an elliptical cylinder, the transparent object may have a shape such as those shown in FIGS. 10 and 11.

In FIG. 11, a transparent object having a donut shape is shown. A virtual floor is rendered at the user's position, whereas the floor of the real world is rendered in the donut-shaped area surrounding the user. By determining the transparent object to be donut-shaped, a user can view an image at their position without feeling afraid.

The MR system in the above-described embodiment is a system in which a user experiences the interior environment of a virtual building. However, the MR system may be a system in which a user can experience another virtual world only if the system superimposes CG over the surroundings at the user's feet.

Additionally, a transparent floor may be located at any position if the transparent floor is located on substantially the same plane as a floor of a virtual reality. That is, the position may be dynamically determined on the basis of position and posture information from cameras and position information about the floor of a virtual reality. For example, the position of the transparent floor may be determined to be a position slightly closer to the eye point than the floor of a virtual reality.

Additionally, a process that blurs the border line between a transparent object and a floor object may be added by controlling alpha blending on the edge of the transparent object.

The present invention can be achieved by an apparatus connected to a variety of devices that are operated to achieve the function of the above-described embodiment. The present invention can also be achieved by supplying software program code that achieves the functions of the above-described embodiments (e.g., the functions of the image combining unit 103 and the virtual-reality generation unit 106) to a system or an apparatus and by causing a computer (central processing unit (CPU) or micro-processing unit (MPU)) of the system or apparatus to operate the above-described various devices in accordance with the program code stored.

In such a case, the program code itself of the software achieves the functions of the above-described embodiments. Therefore, the program code itself and means for supplying the program code to the computer (for example, a recording medium storing the program code) can realize the present invention.

Examples of the recording medium storing the program code include a flexible disk, a hard disk, an optical disk, a magneto optical disk, a CD-ROM (compact disk-read only memory), a magnetic tape, a non-volatile memory card, and a ROM (read only memory).

Furthermore, in addition to realizing the functions of the above-described embodiments by the computer executing the supplied program code, the functions of the above-described embodiments can be realized by the program code in cooperation with an OS (operating system) or other application software running on the computer.

Additionally, the functions of the above-described embodiments can be realized by a process in which, after the supplied program is stored in a memory of an add-on expansion board of a computer or a memory of an add-on expansion unit connected to a computer, a CPU in the add-on expansion board or in the add-on expansion unit executes some of or all of the functions in the above-described embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-259626 filed Sep. 7, 2004, which is hereby incorporated by reference herein in its entirety.

What is claimed is:

1. An information processing method for generating an image of a virtual reality and combining the image of the virtual reality with a real-space image to present a combined image to a user, the information processing method comprising:
acquiring a position and posture of the user; and
generating the combined image corresponding to the position and posture of the user based on the position and posture of the user and computer graphics data of the virtual reality such that the real-space image is displayed at the feet of the user.

2. The information processing method according to claim 1, further comprising:
determining, in accordance with the position and posture of the user, a position of a transparent object to be rendered at the feet of the user, the transparent object being included in the computer graphics data of the virtual reality, the position of the transparent object making the image of the virtual reality transparent so that the real-space image is displayed.

3. The information processing method according to claim 2, wherein the virtual reality is the interior of a virtual building, the computer graphics data of the virtual reality includes a floor object, and determining the position of the transparent object comprises determining the position and posture of the transparent object so that the transparent object is placed on substantially the same plane as the floor object.

4. The information processing method according to claim 2, wherein determining the position of the transparent object comprises determining the vertical position of the transparent object in accordance with the vertical position of the floor object.

5. The information processing method according to claim 2, wherein the transparent object is placed directly beneath the user in the vertical direction by translating the transparent object in accordance with the translation of the user.

6. The information processing method according to claim 2, wherein the size of the transparent object changes as the position of the user changes.

7. The information processing method according to claim 2, wherein the dimensions of the transparent object in front of and behind the user differ in accordance with the position of the user.

8. The information processing method according to claim 1, further comprising:
determining whether the position of the user is inside a predetermined region;
wherein, when it is determined that the position of the user is inside the predetermined region, generating the combined image comprises generating the combined image so that the real-space image is displayed at the feet of the user.

9. A program comprising program code for causing a computer to execute the information processing method according to claim 1.

10. An information processing apparatus for generating an image of a virtual reality and combining the image of the virtual reality with a real-space image to present a combined image to a user, comprising:
an acquiring unit configured to acquire a position and posture of the user; and
a generating unit configured to generate the combined image corresponding to the position and posture of the user based on the position and posture of the user and computer graphics data of the virtual reality such that the real-space image is displayed at the feet of the user.

11. The information processing apparatus according to claim 10, further comprising:
a determining unit configured to determine, in accordance with the position and posture of the user, a position of a transparent object to be rendered at the feet of the user, the transparent object being included in the computer graphics data of the virtual posture, the position of the transparent object making the image of the virtual reality transparent so that the real-space image is displayed.

12. The information processing apparatus according to claim 11, wherein the virtual reality is the interior of a virtual building, the computer graphics data of the virtual reality includes a floor object, and the determining unit is configured to determine the position and posture of the transparent object so that the transparent object is placed on substantially the same plane as the floor object.

13. The information processing apparatus according to claim 11, wherein the determining unit is configured to determine the vertical position of the transparent object in accordance with the vertical position of the floor object.

14. The information processing apparatus according to claim 11, wherein the transparent object is placed directly beneath the user in the vertical direction by translating the transparent object in accordance with the translation of the user.

15. The information processing apparatus according to claim 11, wherein the size of the transparent object changes as the position of the user changes.

16. The information processing apparatus according to claim 11, wherein the dimensions of the transparent object in front of and behind the user differ in accordance with the position of the user.

17. The information processing apparatus according to claim 10, further comprising:
a determining unit configured to determine whether the position of the user is inside a predetermined region;
wherein, when the determining unit determines that the position of the user is inside the predetermined region, the generating unit is configured to generate the combined image so that the real-space image is displayed at the feet of the user.
